(19) United States
(12) Patent Application Publication
(10) Pub. No.: US 2014/0215582 A1
(43) Pub. Date: Jul. 31, 2014

(54) VERIFICATION SYSTEM AND VERIFICATION METHOD

(71) Applicant: Chunghwa Telecom Co., Ltd., Taipei (TW)

(72) Inventors: Yi-Shou Lin, Taipei (TW); Chih-Ming Hsueh, Taipei (TW); Lun-Chuan Lee, Taipei (TW); Jinn-Shu Chang, Taipei (TW); Yung-Zen Lai, Taipei (TW)

(73) Assignee: Chunghwa Telecom Co., Ltd., Taipei (TW)

(21) Appl. No.: 13/952,928

(22) Filed: Jul. 29, 2013

(30) Foreign Application Priority Data
Jan. 31, 2013 (TW) 102103664

(51) Int. Cl. H04L 29/06

(52) U.S. Cl. CPC H04L 63/10
USPC 726/5

(57) ABSTRACT

A verification system and a verification method are provided. After a user inputs an account number and a password in a display interface provided by a first electronic device, it is determined whether first geographic information of the first electronic device is located within a limited region of second geographic information or a trusted region. If it is determined that the first geographic information is located within the limited region of the second geographic information or the trusted region, the first electronic device is allowed to access a network service platform, or the first electronic device is declined to access the network service platform, thereby increasing network security without complicating operations.

### BACKGROUND OF THE INVENTION

1. Field of the Invention

This invention relates to information security techniques, and, more particularly, to a verification system and a verification method that combine with a positioning technique.

2. Description of Related Art

A user logging-in technique is one basic function of any application system, and is especially important to a network involving financial transactions or personal information.

In a login identification process for a conventional network, login information, such as account numbers and passwords, are input to a display interface of a user device. A variety of spy programs is popular in a network environment, and is difficult to find. The spy programs steal users' information unknowingly, including users' secrets and properties.

In response, network service providers develop various types of passwords and a two-step verification method, such as smart card chip verification method, one time password (OTP) dynamic password, and cellular phone short message in-time one time password, which require a user not only to input an account number and a password when logging in a network, but also to input a set of special passwords or insert a smart card into a reading machine. However, these solutions cannot work unless the user performs additional operations or buy a smart card reading machine or a dynamic password generator. Therefore, the user has to manipulate these devices first and then input passwords, which may reduce the threat that the account number is used by others, but unduly affect the user from using the network services normally.

Therefore, how to design a safe and easy-to-operate verification system and verification method is an urgent issue in the art.

### SUMMARY OF THE INVENTION

It is an objective of the present invention to provide a verification system and a verification method to enhance the security when a user uses an account number and a password.

It is another objective of the present invention to provide a verification system and a verification method that are not complicated and are easy to operate.

The present invention provides a verification system, comprising: a network service platform; a first electronic device connected to the network service platform; a second electronic device; and a verifying platform, comprising: a setting module for setting an account number, a password, a limited region and a trusted region for a user to login the network service platform; a login module for the user to input the account number and the password by using the first electronic device, to login the network service platform by using the login module; a positioning module for acquiring first geographic information of the first electronic device and second geographic information of the second electronic device; and a verifying module for determining whether the first geographic information of the first electronic device is located within the limited region of the second geographic information of the second electronic device or the trusted region.

The present invention further provides a verification method applied to a verification system, the method comprising: setting an account number, a password, a limited region and a trusted region for a user to login a network service platform; inputting the account number and the password to login the network service platform; enabling the verification system to acquire first geographic information of a first electronic device; enabling the verification system to acquire second geographic information of a second electronic device; and determining whether the first geographic information of the first electronic device is located within the limited region of the second geographic information of the second electronic device or the trusted region.

Compared with the prior art, the present invention provides a verification system and a verification method that combine with a positioning technique, such that after a user inputs the account number and the password by using the first electronic device, the legality of user will be determined by identifying the first geographic information of the first electronic device and the second geographic information of the second electronic device. Therefore, the security when the user uses the account number and the password is enhanced, and the complexity and difficulty of operation are not increased.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a verification system of an embodiment according to the present invention; and

FIG. 2A and FIG. 2B are flow charts of a verification method of an embodiment according to the present invention.

### DETAILED DESCRIPTION OF THE INVENTION

The following illustrative embodiments are provided to illustrate the disclosure of the present invention; these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

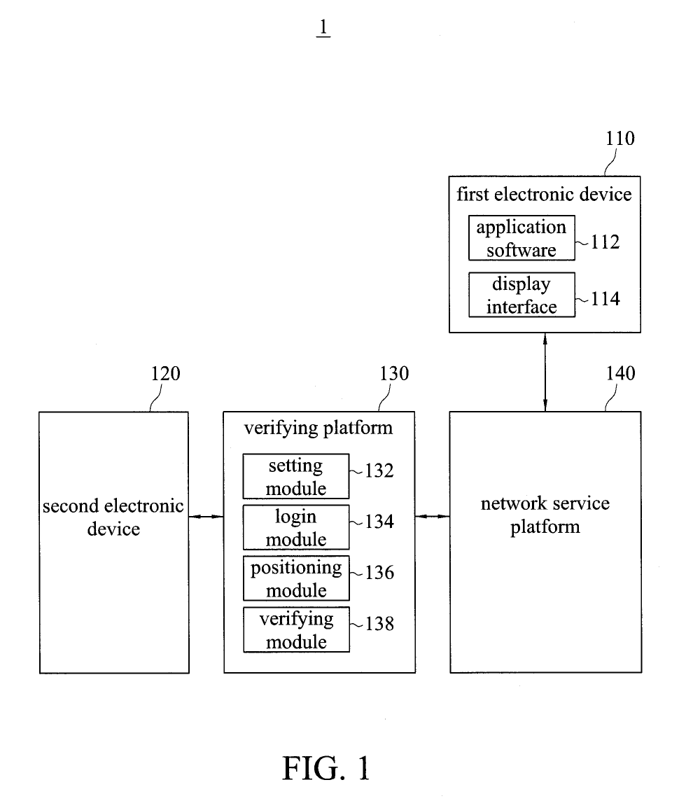

Refer to FIG. 1. A verification system 1 of an embodiment according to the present invention comprises a first electronic device 110, a second electronic device 120, a verifying platform 130 and a network service platform 140. In an embodiment, the verifying platform 130 is a multi-factor geographic location information-based verifying platform.

In an embodiment, the first electronic device 110 is connected to the network service platform 140 in a wired or wireless manner, and is a stationary electronic device such as a desktop computer or a mobile electronic device, such as a laptop computer, a tablet computer or a smart phone. Application software 112, such as APP programs or network browsers, are installed in the first electronic device 110, for the first electronic device 110 to be connected to the network service platform 140 via a network system (not shown).

The verifying platform 130 comprises a setting module 132, a login module 134, a positioning module 136 and a verifying module 138.

The setting module 132 is used for setting an account number, a password, a limited region and a trusted region for a user to login the network service platform 140. Before logging in the network service platform 140, the user may set in the setting module 132 the account number and the password that are used to login the network service platform 140, and further set the trusted region (e.g., a geographic location such as home and office) wherein the network service platform 140 is allowed to login. The setting module 132 also sets the electronic device 120 that the network service platform 140 can identify and the scope of the limited region, such as 10 kilometers, 1 kilometer, etc.

The login module 134 is used to receive information (e.g., the account number and the password) input by the user in the display interface 114 of the first electronic device 110 and logged into the network service platform 140. Therefore, the user is allowed to login the network service platform 140 through the login module 134.

The positioning module 136 is used for acquiring first geographic information of the first electronic device 110. In an embodiment, the positioning module 136 can identify geographic location information (e.g., longitude and latitude information) of the first electronic device 110 by acquiring network access point information of the first electronic device 110. If the first electronic device 110 is connected to the network system in the wired manner, the positioning module 136 determines the geographic location information of the first electronic device 110 by acquiring IP address information of the first electronic device 110 and looking up the IP address information. If the first electronic device 110 is connected to the network system in the wireless manner, the positioning module 136 acquires the geographic location information of the first electronic device 110 by acquiring Wi-Fi hot spot information connected to the first electronic device 110 and looking up the Wi-Fi hot spot information. In another embodiment, the first electronic device 110 is equipped with a GPS device that transmits the current geographic location information of the first electronic device 110 to the positioning module 136 actively.

The positioning module 136 is further used for acquiring second geographic information of the second electronic device 120. In an embodiment, the second electronic device 120 is a portable electronic device of the user, which uses a registration location of a base station to determine the geographic location information (e.g., longitude and latitude) of the second electronic device 120.

The verifying module 138 is used for, when the user logins the network service platform 140 through the first electronic device 110, determining whether the first geographic information of the first electronic device 110 acquired by the positioning module 136 is located within the limited region (e.g., within 10 kilometers) of the second geographic information of the second electronic device 120 or within the trusted region (e.g., office) set by the setting module 132. If the first geographic information is determined to be located within the limited region of the second geographic information or the trusted region, the first electronic device 110 is allowed to access the network service platform 140. On the contrary, if the first geographic information is determined to be outside the trusted region and is not located within the limited region of the second geographic information, the first electronic device 110 is declined to access the network service platform 140, and the user is notified of a short message or an e-mail.

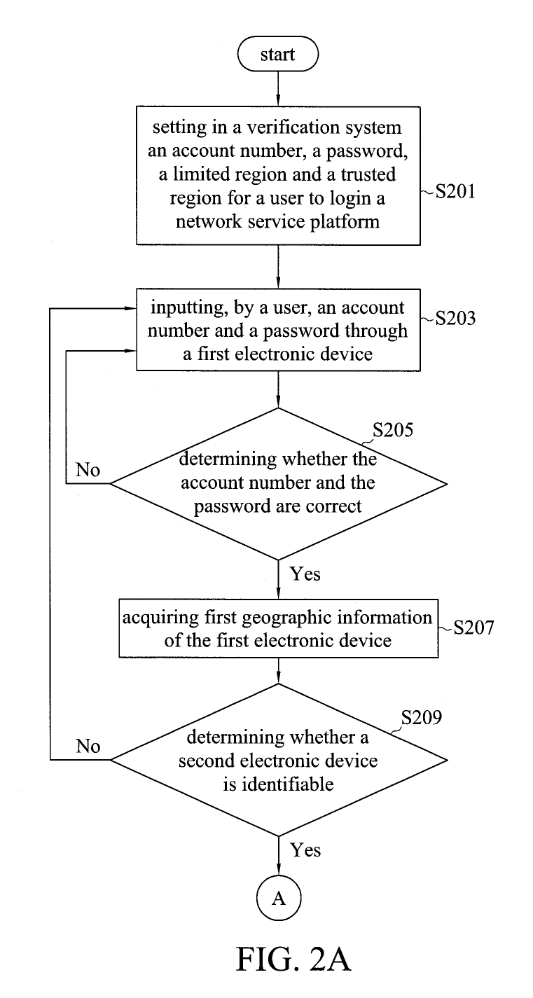

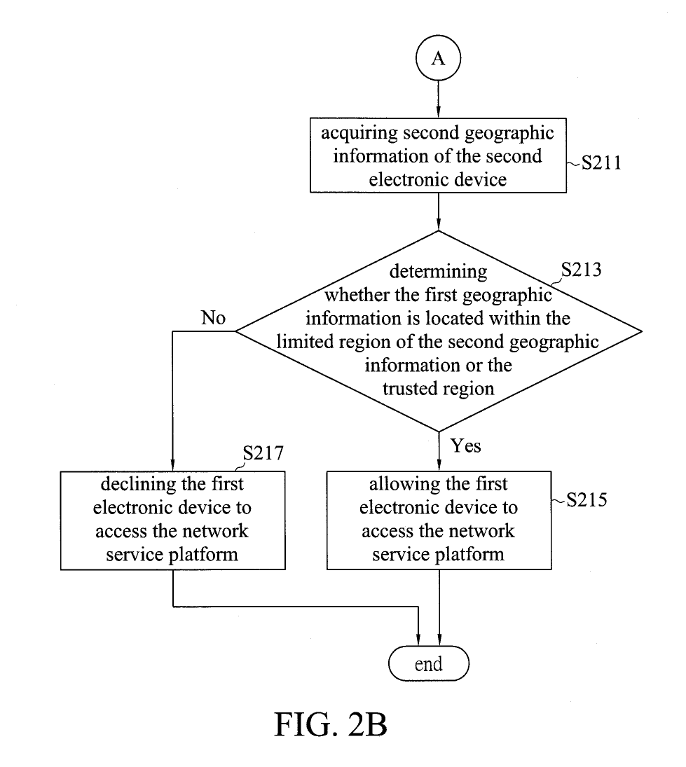

FIG. 2A and FIG. 2B are flow charts of a verification method of an embodiment according to the present invention. The verification method is applied to the verification system 1 shown in FIG. 1. As shown in FIG. 2A and FIG. 2B, step S201 is executed first. In the verification system 1, an account number, a password, a limited region and a trusted region are set for a user to login the network service platform 140. The verification method proceeds to step S203.

In step S203, a display interface is provided for the user to input the account number and the password through the first electronic device 110. The verification method proceeds to step S205.

In step S205, it is determined whether the input account number and the password are correct. If the input account number and password are correct, the verification method proceeds to step S207, or the verification method returns to step S203.

In step S207, the verification system 1 is enabled to acquire the first geographic information of the first electronic device 110. In an embodiment, the first electronic device 110 is connected to the network service platform 140 in a wired or wireless manner. The verification system 1 identifies the first geographic information of the first electronic device 110 by acquiring and looking up network access point information (e.g., IP address information or WI-FI hot spot information). In another embodiment, the first electronic device 110 is equipped with a GPS device, and the verification system 1 can identify the current first geographic information of first electronic device 110 through the geographic location information returned by the GPS device. The verification method proceeds to step S209.

In step S209, it is determined whether the second electronic device 120 is a device identifiable by the network service platform 140. If the second electronic device 120 is a device that is identifiable by the network service platform 140, the verification method proceeds to step S211, or the verification method returns to step S203.

In step S211, the verification system 1 is enabled to acquire the second geographic information of the second electronic device 120. The verification method proceeds to step S213. In step S213, it is determined whether the first geographic information of the first electronic device 110 is located within the limited region of the second geographic information of the second electronic device 120 or the trusted region. If the first geographic information is determined to be located within the limited region of the second geographic information or the trusted region, the verification method proceeds to step S215; on the contrary, if the first geographic information is determined to be outside the trusted region and is not located within the limited region of the second geographic information, the verification method proceeds to step S217.

In step S215, the first electronic device 110 is allowed to access the network service platform 140, and the verification method ends.

In step S217, the first electronic device 110 is declined to access the network service platform 140, the user is notified of a short message or an e-mail, and the verification method ends.

In sum, a verification system and a verification method according to the present invention utilize a positioning technique for an electronic device to enhance the security when a user is using his account number and password. When the user logins a network service platform through a first electronic device, the legality of the user's logging in the network service platform can be determined by identifying whether first geographic information of the first electronic device is located within a limited region of second geographic information of a second electronic device or a trusted region, thereby increasing network security without complicating operations.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A verification system, comprising:
a network service platform;
a first electronic device connected to the network service platform;
a second electronic device; and
a verifying platform, comprising:
a setting module for setting an account number, a password, a limited region and a trusted region for a user to login the network service platform;
a login module for the user to input the account number and the password by using the first electronic device, to login the network service platform by using the login module;
a positioning module for acquiring first geographic information of the first electronic device and second geographic information of the second electronic device; and
a verifying module for determining whether the first geographic information of the first electronic device is located within the limited region of the second geographic information of the second electronic device or the trusted region.

2. The verification system of claim 1, wherein if the first geographic information is located within the limited region of the second geographic information or the trusted region, the first electronic device is allowed to access the network service platform; otherwise if the first geographic information is located outside the trusted region and is not located within the limited region of the second geographic information, the first electronic device is declined to access the network service platform.

3. The verification system of claim 1, wherein the first electronic device is connected to the network service platform in a wired or wireless manner.

4. The verification system of claim 1, wherein the positioning module identifies the first geographic information of the first electronic device by acquiring network access point information of the first electronic device.

5. The verification system of claim 1, wherein the first electronic device is provided with a GPS device for the positioning module to identify the first geographic information of the first electronic device.

6. The verification system of claim 1, wherein the second electronic device uses a registration location of a base station to determine the second geographic information of the second electronic device.

7. A verification method applied to a verification system, comprising the steps of:
setting an account number, a password, a limited region and a trusted region for a user to login a network service platform;
inputting the account number and the password to login the network service platform;
enabling the verification system to acquire first geographic information of a first electronic device;
enabling the verification system to acquire second geographic information of a second electronic device; and
determining whether the first geographic information of the first electronic device is located within the limited region of the second geographic information of the second electronic device or the trusted region.

8. The verification method of claim 7, wherein if the first geographic information is located within the limited region of the second geographic information or the trusted region, the first electronic device is allowed to access the network service platform; otherwise if the first geographic information is located outside the trusted region and is not located within the limited region of the second geographic information, the first electronic device is declined to access the network service platform.

9. The verification method of claim 7, wherein the first electronic device is connected to the network service platform in a wired or wireless manner.

10. The verification method of claim 7, wherein the verification system identifies the first geographic information of the first electronic device by acquiring network access point information of the first electronic device.

11. The verification method of claim 7, wherein the first electronic device is provided with a GPS device and identifies the first geographic information of the first electronic device through the GPS device.

12. The verification method of claim 7, wherein the second electronic device uses a registration location of a base station to determine the second geographic information of the second electronic device.
